(19) United States
(12) Patent Application Publication
(10) Pub. No.: US 2022/0410679 A1
(43) Pub. Date: Dec. 29, 2022

(54) Aluminum roll bed liner for pickup truck

(71) Applicant: Wenzhou Tianmao Automobile Parts Co.,Ltd, Wenzhou City (CN)

(72) Inventor: Lanhua Cai, Ruian City (CN)

(21) Appl. No.: 17/357,970

(22) Filed: Jun. 24, 2021

(51) Int. Cl. B60J 7/14

(52) U.S. Cl. CPC B60J 7/141

(57) ABSTRACT

The invention shows an aluminum roll bed liner for pickup truck, wherein includes a guide strut assembly, a roll bed liner body and a fixing clamp assembly. The guide strut assembly is connected to the cargo hopper by the fixing clamp assembly, the roll bed liner body is connected with the guide strut assembly, the roll bed liner body includes a front bar fixing assembly, a roll bed liner assembly and a rear bar fixing assembly, the front bar fixing assembly and the rear bar fixing assembly are connected to both ends of the roll bed liner assembly. By setting guide strut assembly, it makes the cover body arranged along the guide strut, the cover body is designed as a roll cover type, so that the cover body can be opened easily and the opening space is larger.

### TECHNICAL FIELD

This invention is relevant to automobile accessories field, especially about the aluminum roll bed liner for pickup truck.

### BACKGROUND TECHNOLOGY

Pickup truck plays an important role in the automobile market. It is a kind of car with car head, cab and cargo hopper. It is characterized in comfortable driving experience and strong power like a car, but it has a stronger loading capacity and the ability to adapt to poor roads than a car.

The powerful loading capacity of pick-up trucks greatly increases the scope of application, however, most of the existing pickup trucks have no cover, which makes the use of pickup trucks vulnerable to the weather, thus it appears a kind of pickup truck with horizontal push hard cover. However, due to the characteristics of the hard cover plate, the opening angle of the cover body is not large enough, which is very inconvenient in the use.

### About the Invention

The purpose of the invention is to provide an aluminum roll bed liner for pickup truck, the bed liner body can be rolled up by changing the structure of the cover body, so that make the cover body more convenient in use.

To solve the existing technical problem above, thus the invention use the following method:

An aluminum roll bed liner for pickup truck, includes a guide strut assembly, a roll bed liner body and a fixing clamp assembly.

The guide strut assembly is connected to cargo hopper by fixing clamp assembly.

The roll bed liner body is connected to guide strut assembly, the roll bed liner body includes a front bar fixing assembly, a roll bed liner assembly and a rear bar fixing assembly, the front bar fixing assembly and rear bar fixing assembly are respectively connected to both ends of the roll bed liner assembly.

By setting the guide strut assembly, the bed liner body is arranged along the guide strut assembly, the bed liner body is designed as a roll cover type, so that the bed liner body is not only easy to open, but also has larger opening space.

The guide strut assembly includes a guide strut frame, a front fixing assembly and a rear fixing assembly, there are two guide strut frames, the two guide strut frames are respectively connected to both sides of the cargo hopper, two ends of guide strut frame are respectively connected with a front fixing assembly and a rear fixing assembly, the guide strut frame is provided with a rotating cavity, a connecting hole and a mounting groove.

The front fixing assembly includes a sleeve and a torsion spring, the sleeve is provided with a first sleeve hole and a second sleeve hole, the torsion spring is provided with a first torsion spring hole and a second torsion spring hole, as the rotation axis of the torsion spring, one screw passes through the second sleeve hole and the second torsion spring hole and connects to the connecting hole, the torsion spring and the sleeve can rotate relative to the screw, another screw passes through the first sleeve hole and the first torsion spring hole and extends into the rotating cavity to connect with the pressing strip, so that the pressing strip rotates after the torsion spring, the fixing clamp assembly includes a plurality of fixing clamps, which clamp the guide strut frame and the cargo hopper through the mounting groove.

The rear fixing assembly includes a sleeve and a torsion spring, the sleeve is provided with a first sleeve hole and a second sleeve hole, the torsion spring is provided with a first torsion spring hole and a second torsion spring hole, as the rotation axis of the torsion spring, one screw passes through the second sleeve hole and the second torsion spring hole and connects to the connecting hole, another screw passes through the first sleeve hole and the first torsion spring hole, extends into the rotating cavity to connect with the pressing strip, so that the pressing strip rotates after the torsion spring. The rear fixing assembly also provided with a pressing piece, which is used to connect with the sleeve, and which is extended to the middle of the bed liner body. The side of the rotating cavity close to the rolling bed liner assembly is provided with a mounting port for passing through the pressure strip. By setting front fixing assembly, rear fixing assembly and pressing strip, the pressing strip follow the torsion spring to rotate, only press the pressing piece by the rear bar fixing assembly, the pressing strip can be driven to clamp the edge of the whole roll bed liner assembly, which makes the operation convenient.

The roll bed liner assembly includes a waterproof rubber strip, a plurality of first profiles and a plurality of second profiles, the first profiles and the second profiles are criss-crossed and hinged with each other, the end of the first profile is connected with a joint, the waterproof rubber strip is fitted into the joint, and a plurality of joints are connected in series, both ends of the second profile are provided with a T-shaped structure, both ends of the first profile are provided with notches for clamping the T-shaped structure, the upper part of the second profile is flat, the upper part makes a whole plane when the roll bed liner assembly is unfolded, the lower part of the second profile is a notch, so that it can be rolled down, the roll bed liner assembly is designed as a hinge structure formed by the mutual splicing of a plurality of profiles, so that the bed liner body can be rolled up, which is convenient for taking and placing.

One end of the roll bed liner assembly is connected with a front bar fixing assembly, the other end of the roll bed liner assembly is connected with a rear bar fixing assembly, the front bar fixing assembly includes a T-shaped rod, a front bar clamp and a large front bar, the front bar fixing clamp is connected with the mounting groove of the guide strut frame, the large front bar is hinged with the roll bed liner assembly through the second profile, the T-shaped rod is connected with the large front bar through the front bar clamp, the larger end of the T-shaped rod extends into the groove of the large front bar while the other end of the T-shaped rod connects with a nut, the rear bar fixing assembly includes a lock assembly and a large rear bar, the large rear bar is connected to the end of the roll bed liner assembly far away from the large front bar, the large rear bar is provided with a sliding groove.

The lock assembly includes a fixing block, a pull block and a lock tab, the fixing block and the pull block are both placed in the sliding groove, the fixing block is fixedly arranged on the large rear bar, the pull block is arranged on the side of the fixing block close to the guide strut frame, an elastic part is arranged between the pull block and the fixing block, the elastic part is in a compressed state, the pull block is connected with a lock tab for clamping the guide strut frame, there are two lock assemblys, each lock assembly corresponds to a guide strut frame respectively, by setting the lock assembly, pressing the pressing piece to lock the rear bar fixing assembly to prevent it from loosening, the lock assembly is designed as a combined structure of the fixing block and the pulling block, which is convenient to open and can guarantee enough locking force, the front bar fixing assembly also includes two front plugs, which are respectively connected to both ends of the large front bar, the front plug is connected to the large front bar by screws, the rear bar assembly also includes two rear plugs, which are respectively connected to both ends of the large rear bar, the rear plug is connected to the large rear bar by screws, the front plugs, the rear plugs and the joints are both provided with clamping grooves for clamping the waterproof rubber strip, the waterproof rubber strip is clamped in the clamping groove, and the front plug, the rear plug and a plurality of joints are connected in series, the waterproof rubber strip is provided with a clamping end, the clamping end is embedded in the clamping groove, by setting the front plug and rear plug 55, the waterproof rubber strip 4 runs through the whole roll bed liner body 2, so as to improve the overall waterproof effect.

The roll bed liner body includes a binding assembly, which includes a binding rope and a hook, the binding rope is connected with the lower side of the roll bed liner body, the hook is connected with the upper side of the roll bed liner body, when the roll bed liner body is rolled up, the binding rope is clamped into the socket fixed by the hook. An inclined plane is arranged on the side of the hook close to the roll bed liner assembly to position the rolled bed liner cover, by setting the binding assembly, the roll bed liner body 2 can be rolled up to fold and bind, providing various methods of use.

Furthermore, the side of the bed liner body far away from the cargo hopper is provided with a waterproof sheet, the edge of the waterproof sheet is inserted into the waterproof groove, the addition of the waterproof sheet does not affect the winding, but also makes the overall waterproof effect better.

Compared with the prior art, the invention provides a waterproof embedded car cover for pickup truck through this design, which is more convenient to use. In this design, the car cover is integrally installed in the cargo hopper of the pickup truck, the front rail, the bed liner body, the rear rail and other structures form a closed car cover, and the waterproof effect of the car cover is improved by using a waterproof adhesive strip; Moreover, the cover plate of the car cover can be turned up at a larger angle, and the locking device is convenient to use, which improves the user's experience.

### DESCRIPTION OF DRAWINGS

FIG. 1 is a installation drawing 1 of the roll bed cover in the invention;

FIG. 2 is a installation drawing 2 of the roll bed cover in the invention;

FIG. 3 is a structure illustration 1 of the roll bed cover in the invention;

FIG. 4 is a structure illustration 2 of the roll bed cover in the invention;

FIG. 5 is a partial enlarged diagram of part A in FIG. 4;

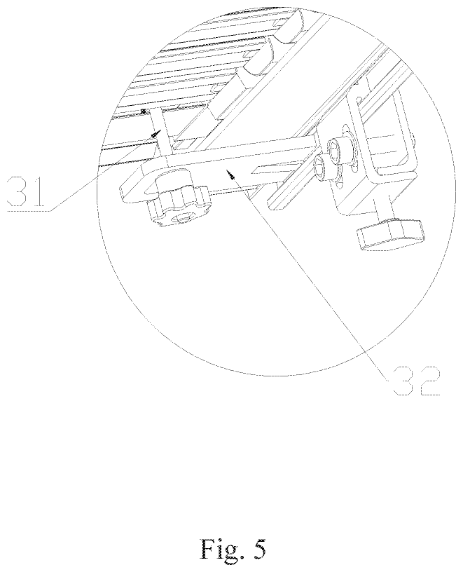

FIG. 6 is a 3D schematic diagram 1 of the invention;

FIG. 7 is a partial enlarged diagram of part B in FIG. 6;

FIG. 8 is a 3D schematic diagram 2 of the invention;

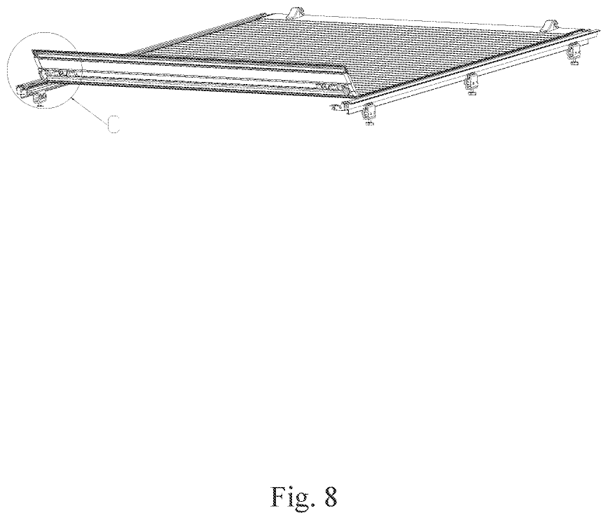

FIG. 9 is a partial enlarged diagram of part C in FIG. 8;

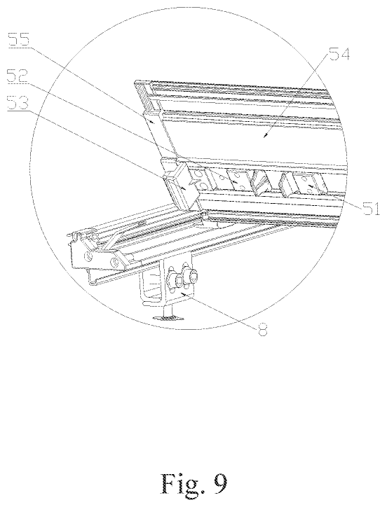

FIG. 10 is a structure illustration of the guide strut frame in the invention;

FIG. 11 is a structure illustration of the Front mounting assembly in FIG. 10;

FIG. 12 is a structure illustration of the Rear mounting assembly in FIG. 10;

FIG. 13 is a structure illustration of the Roll bed liner in the invention;

FIG. 14 is a partial structure illustration of the Roll bed liner in the invention;

FIG. 15 is a partial enlarged diagram of part D in FIG. 14;

FIG. 16 is a main view of the waterproof adhesive strip in the invention;

FIG. 17 is a side view of the guide strut frame in the invention;

1—Cargo hopper; 2—Roll bed liner body; 3—Front bar fixing assembly; 31—T-shaped rod; 32—Front bar clamp; 4—Waterproof Strip; 41—Snap end; 42—Waterproof groove; 5—Rear bar fixing assembly; 51—Fixing block; 52—Pull block; 53—Locking tab; 54—Rear bar; 55—Rear fixing block; 61—Binding rope; 62—Hook; 8—Fixing clamp assembly; 9—guide strut assembly; 91—guide strut frame; 911—Rotating cavity; 912—Connecting hole; 913—mounting groove; 92—Sleeve; 921—First sleeve hole; 922—Second sleeve hole; 93—Torsion spring; 931—First torsion spring hole; 932—Second torsion spring hole; 94—Pressing strip; 95—End cap; 96—Pressing piece; 10—Roll bed liner assembly; 101—First profile; 102—Second profile; 103—Joint; 1031—Grooves; 1032—Supporting platform.

The Concrete Method to Carry Out

The following instruction is to further explain the concrete implementation method in the invention.

In order to enable us to better understand the above purposes, features and advantages of the invention, the invention will be described in detail in combination with the drawings and specific concrete method. It should be noted that in the case of no conflict, the features of the embodiments and embodiments of the application can be combined.

The terms “first”, “second”, “third” and so on are only used to distinguish descriptions, but cannot be understood as indicating or implying relative importance.

In the description of the invention, it should also be noted that unless otherwise specified and limited, the terms “setting”, “installation”, “connection” and “connection” should be understood in a broad sense. For example, they can be fixed connection, detachable connection or integrated connection; it can be mechanical connection or electrical connection; it can also be directly connected, or indirectly connected through intermediate media, or internal connection of two components. For those of ordinary skill in the art, the specific meaning of the above terms in the present invention can be understood in specific cases.

The following is a detailed description of the specific implementation mode of the invention in combination with the drawings. It should be understood that the specific concrete method described herein are only used to illustrate and explain the invention and are not used to limit the invention.

Method 1:

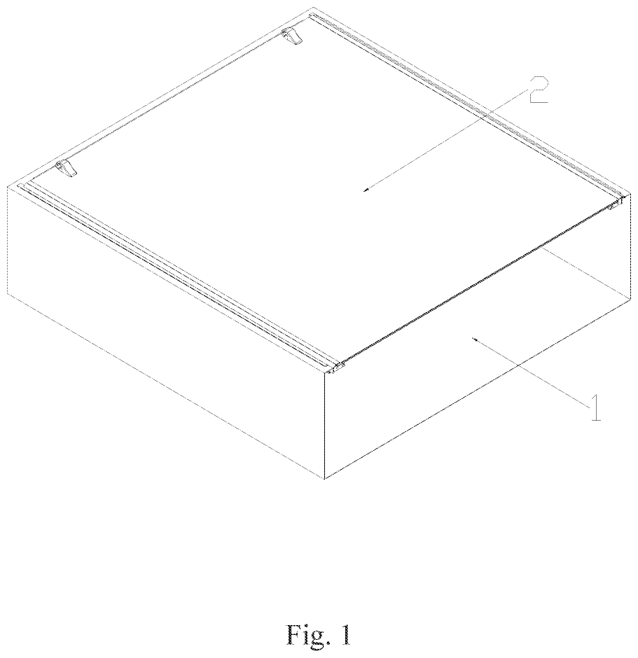

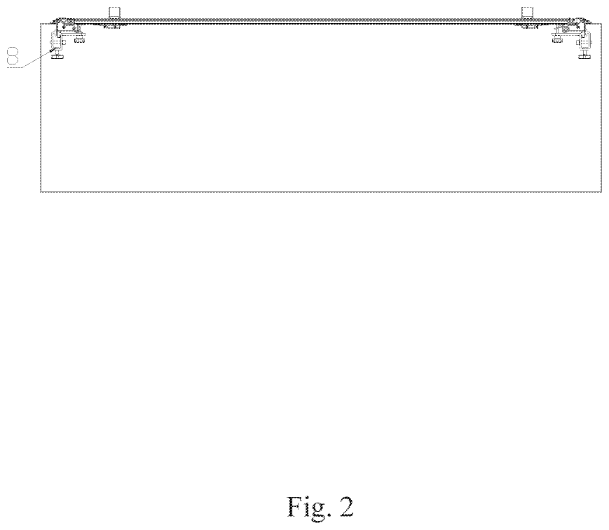

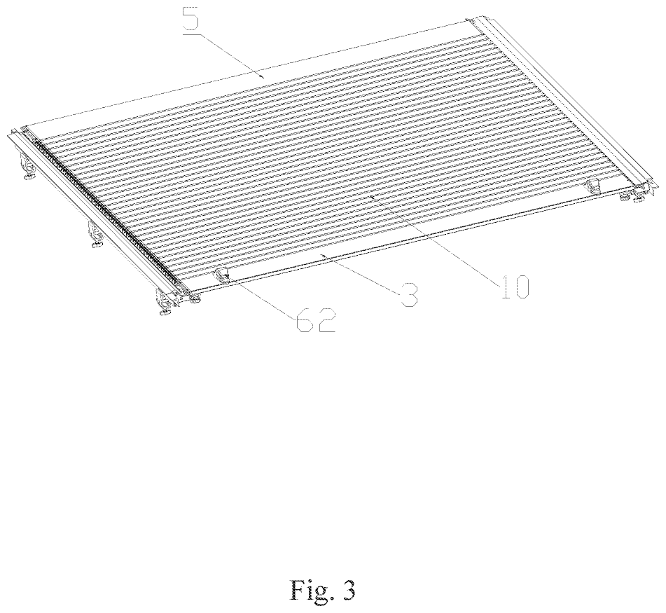

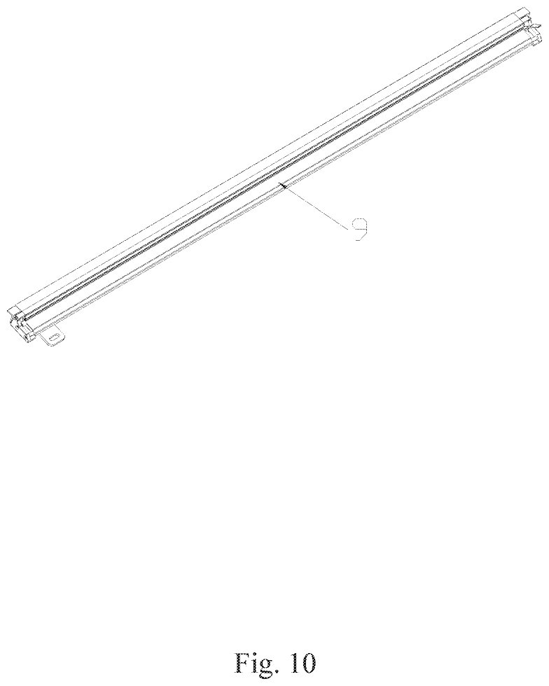

As is seen from FIGS. 1 to 3 and 10, an aluminum roll bed liner for pickup truck includes a guide strut assembly 9, a roll bed liner body 2 and a fixing clamp assembly 8.

the guide strut assembly 9 is connected to cargo hopper 1 by fixing clamp assembly 8.

the roll bed liner body 2 is connected with the guide strut assembly 9, the roll bed liner body 2 includes a front bar fixing assembly 3, a roll bed liner assembly 10 and rear bar fixing assembly 5, the front bar fixing assembly 3 and rear bar fixing assembly 5 are respectively connected to both ends of the roll bed liner assembly 10.

By setting the guide strut assembly 9, the bed liner body 2 is arranged along the guide strut assembly 9, and the bed liner body 2 is designed as a roll cover type, so that the bed liner body 2 is not only easy to open, but also has larger opening space.

Method 2:

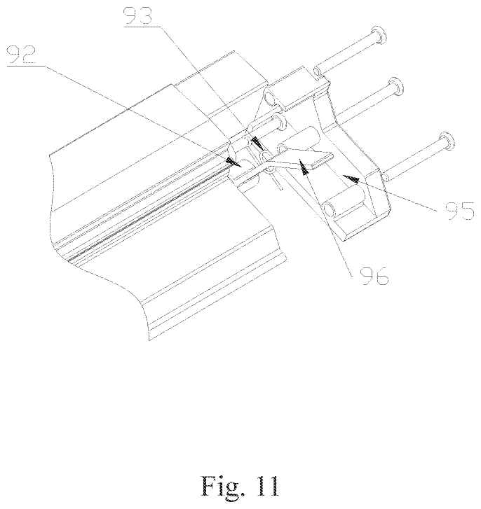

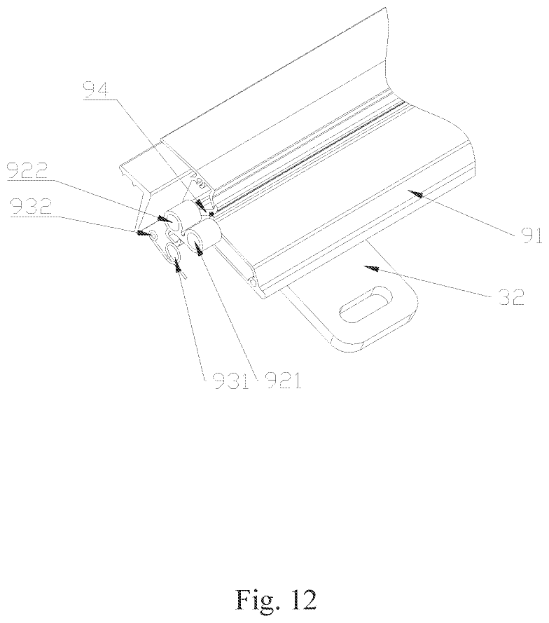

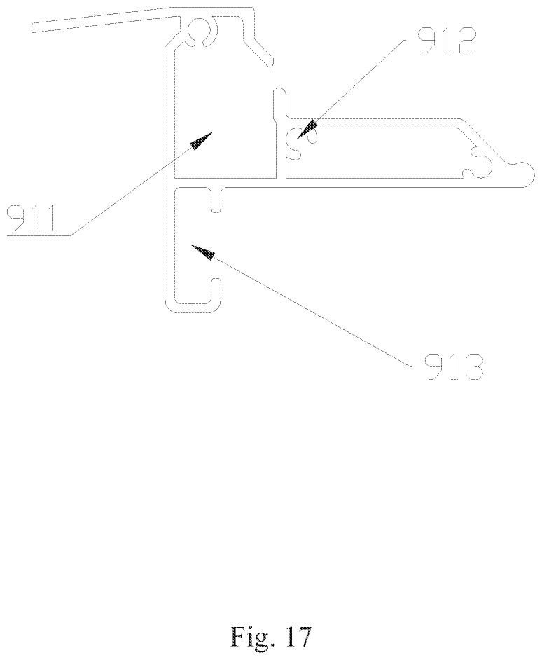

On the basis of method 1, as shown in FIGS. 11, 12 and 17, the guide strut assembly 9 includes a guide strut frame 91, a front fixing assembly and a rear fixing assembly; there are the two guide strut frames, the two guide strut frames are respectively connected to both sides of the cargo hopper 1, two ends of guide strut frame 91 are respectively connected with a front fixing assembly and a rear fixing assembly.

The guide strut frame 91 is provided with a rotating cavity 911, a connecting hole 912 and a mounting groove 913.

The front fixing assembly includes a sleeve 92 and a torsion spring 93, the sleeve 92 is provided with a first sleeve hole 921 and a second sleeve hole 922, the torsion spring 93 is provided with a first torsion spring hole 931 and a second torsion spring hole 932, as the rotation axis of the torsion spring 93, one screw passes through the second sleeve hole 922 and second torsion spring hole 932 and connects to connecting hole 912, the torsion spring 93 and the sleeve 92 can rotate relative to the screw, another screw passes through the first sleeve hole 921 of the sleeve and the first torsion spring hole 931 of the torsion spring and extends into the rotating cavity 911 to connects with the pressing strip 94, so that the pressing strip 94 rotates after the torsion spring 93.

The fixing clamp assembly 8 includes a plurality of fixing clamps, which clamp the guide strut frame 91 and the cargo hopper 1 through the mounting groove 913.

The rear fixing assembly includes a sleeve 92 and a torsion spring 93, the sleeve 92 is provided with a first sleeve hole 921 and a second sleeve hole 922, the torsion spring 93 is provided with a first torsion spring hole 931 and a second torsion spring hole 932, as the rotation axis of the torsion spring 93, one screw passes through the second sleeve hole 922 and second torsion spring hole 932 and connects to the connecting hole 912, another screw passes through the first sleeve hole 921 and first torsion spring hole 931, extends into the rotating cavity 911 to connect with the pressing strip 94, so that the pressing strip 94 rotates after the torsion spring 93, the rear fixing assembly also provide with a pressing piece 96 which is used to connect with the sleeve 92, and which is extended in the middle of the roll bed liner body 2

The side of the rotating cavity 911 close to the roll bed liner assembly 10 is provided with a mounting port for passing through the pressing strip 94.

By setting front fixing assembly, rear fixing assembly and pressing strip 94, the pressing strip 94 follow the torsion spring 93 to rotate, only press the pressing piece 96 by the rear bar fixing assembly 5, the pressing strip 94 can be driven to clamp the edge of the whole roll bed liner assembly 10, which makes the operation convenient.

Method 3:

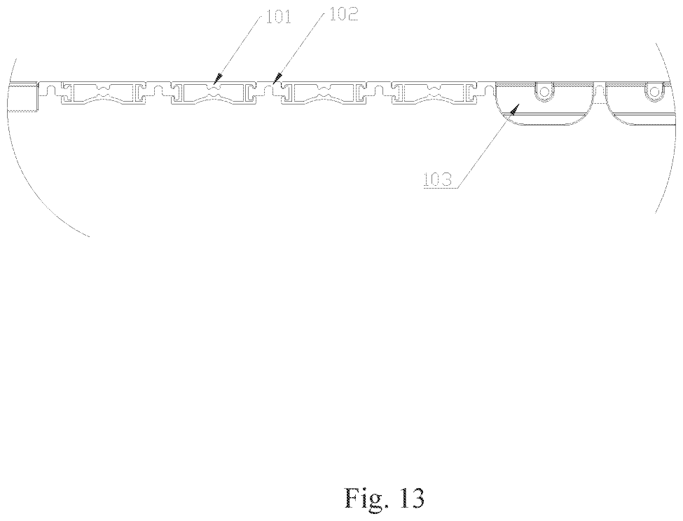

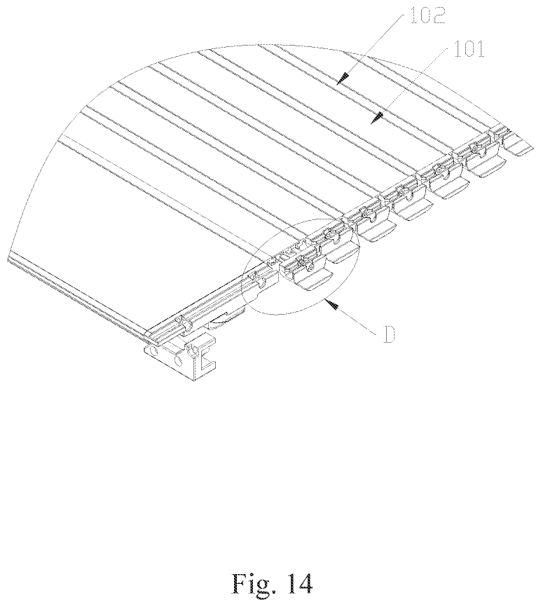

On the basis of method 2, as shown in FIGS. 13 and 14, the roll bed liner assembly 10 includes a waterproof rubber strip 4, a plurality of first profiles 101 and a plurality of second profiles 102, the first profile 101 and the second profile 102 are criss-crossed and hinged with each other, the end of first profiles 101 is connected with a joint 103, the waterproof rubber strip 4 is fitted into the joint 103, and a plurality of joints 103 are connected in series.

Both ends of the second profile 102 are provided with a T-shaped structure, both ends of the first profile 101 are provided with notches for clamping with the T-shaped structure, the upper part of the second profile 102 is flat, the upper part makes a whole plane when the roll bed liner assembly 10 is unfolded, the lower part of the second profile 102 is a notch, so that it can be rolled down.

The roll bed liner assembly 10 is designed as a hinge structure formed by the mutual splicing of a plurality of profiles, so that the bed liner body 2 can be rolled up, which is convenient for taking and placing.

Method 4:

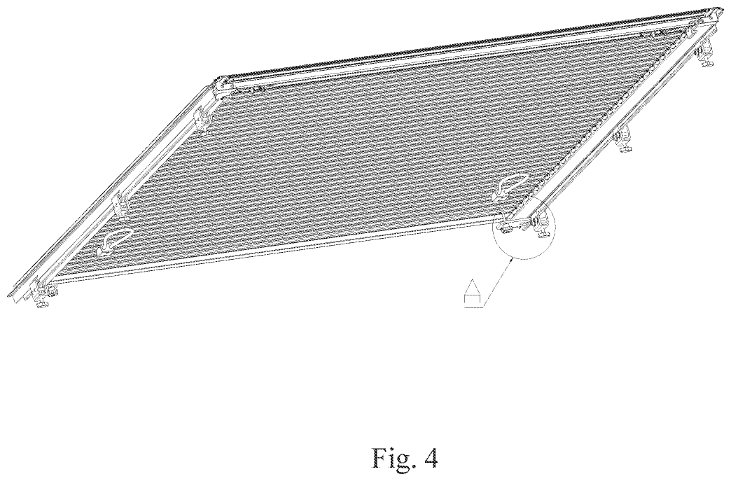

On the basis of method 3, as shown in FIGS. 4,5,8 and 9, one end of the roll bed liner assembly 10 is connected with the front bar fixing assembly 3, the other end of the roll bed liner assembly is connected with the rear bar fixing assembly 5.

the front bar fixing assembly (3) includes a T-shaped rod (31), a front bar clamp (32) and a large front bar,

the front bar clamp 32 is connected with the mounting groove 913 of the guide strut frame 91, the large front bar is hinged with the roll bed liner assembly 10 through the second profile 102, the T-shaped rod 31 is connected with the large front bar through the front bar clamp 32.

The larger end of the T-shaped rod 31 extends into the groove of the large front bar while the other end of the T-shaped rod connects with a nut.

the rear bar fixing assembly 5 includes a lock assembly and a large rear bar 54, the large rear bar 54 is connected to the end of the roll bed liner assembly 10 far away from the large front bar, and the large rear bar 54 is provided with a sliding groove.

Method 5:

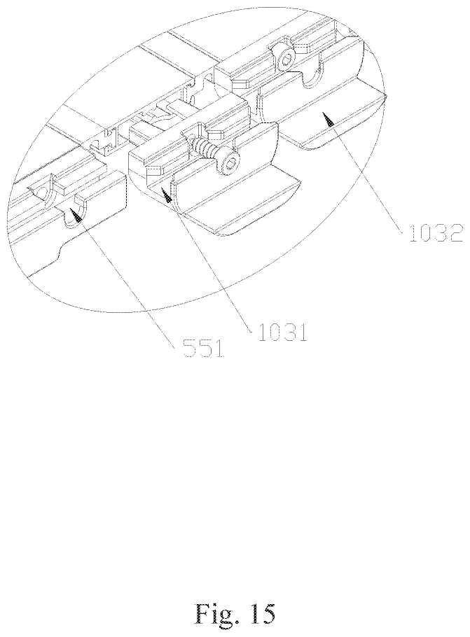

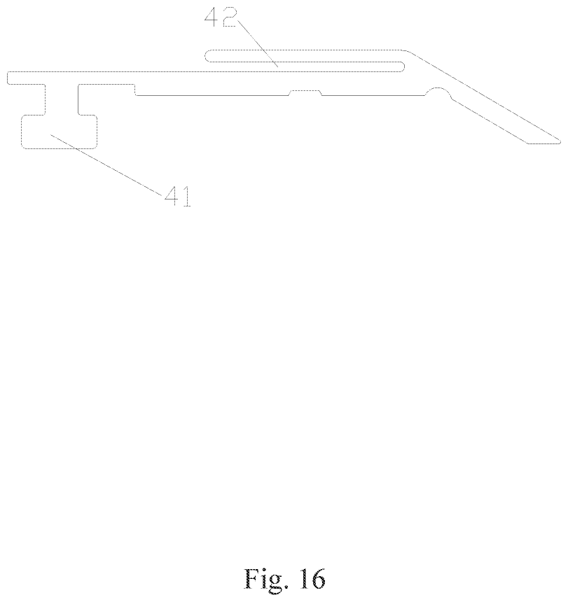

On the basis of method 4, as shown in FIGS. 15 and 16, the lock assembly includes a fixing block (51), a pull block (52) and a locking tab (53), the fixing block (51) and the pull block (52) are both placed in the sliding groove, the fixing block (51) is fixedly arranged on the large rear bar (54), the pull block (52) is arranged on the fixing block (51) close to the guide strut frame (91), an elastic part is arranged between the pull block (52) and the fixing block (51), the elastic part is in a compressed state, the pull block (52) is connected with a locking tab (53) for clamping the guide strut frame (91).

there are two the lock assemblys, each lock assembly corresponds to a guide strut frame 91 respectively.

By setting the lock assembly, pressing the pressing piece 96 to lock the rear bar fixing assembly 5 to prevent it from loosening, the lock assembly is designed as a combined structure of the fixing block 51 and the pull block 52, which is convenient to open and can guarantee enough locking force.

The front bar fixing assembly 3 includes two front plugs, which are respectively connected to both ends of the large front bar.

The front plug is connected to the large front bar by screws.

The rear bar assembly also includes two rear plugs 55, the two rear plugs 55 are respectively connected to both ends of the large rear bar.

The two rear plugs 55 are connected to the large rear bar by screws.

The front plug, the rear plug 55 and the joint 103 are both provided with clamping grooves 1031 for clamping the waterproof rubber strip 4, the waterproof rubber strip 4 is clamped in the clamping groove 1031, and the front plug, the rear fixing block 55 and a plurality of joints 103 are connected in series.

The waterproof rubber strip 4 is provided with a clamping end 41, the clamping end 41 is embedded in the clamping groove 1031.

By setting the front plug and rear plug 55, the waterproof rubber strip 4 runs through the whole roll bed liner body 2, so as to improve the overall waterproof effect.

Method 6:

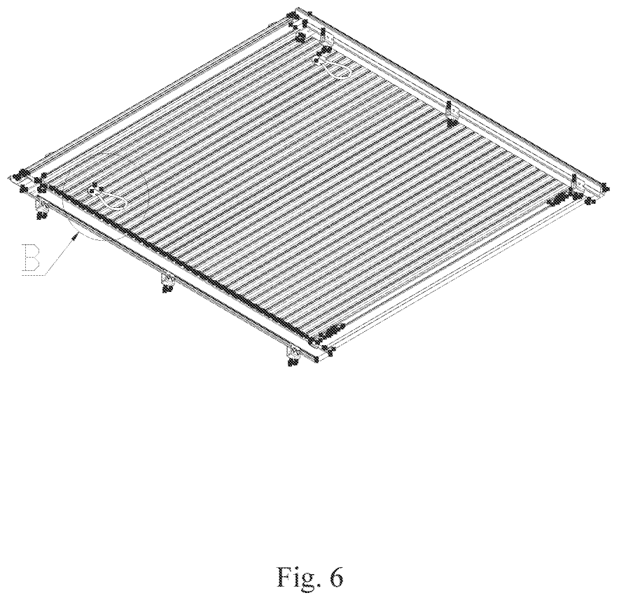

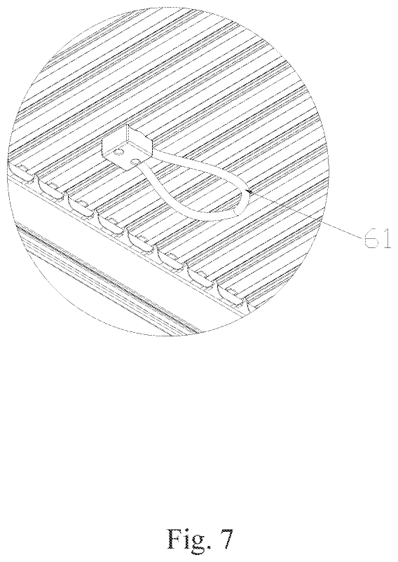

On the basis of method 5, as shown in FIGS. 6 and 7, the roll bed liner body includes a binding assembly, which includes a binding rope 61 and a hook 62, the binding rope 61 is connected with the lower side of the roll bed liner body 2, the hook 62 is connected with the upper side of the roll bed liner body 2, when the roll bed liner body 2 is rolled up, the binding rope 61 is clamped into the socket fixed by the hook 62. An inclined plane is arranged on the side of the hook 62 close to the roll bed liner assembly 10 to position the rolled bed liner cover 2.

By setting the binding assembly, the roll bed liner body 2 can be rolled up to fold and bind, providing various methods of use.

The side of the roll bed liner body 2 far away from the cargo hopper 1 is provided with a waterproof sheet, the edge of the waterproof sheet is inserted into the waterproof groove 42.

The addition of the waterproof sheet does not affect the winding, but also makes the overall waterproof effect better.

Detail Working Principle:

Firstly, connect the guide strut frame 91 to both sides of the cargo hopper 1 by the fixing clamp assembly 8, then extend the end of the pressing strip 94 with the mounting hole into the rotating cavity 911, then connect the screw to the connecting hole 912 through the second sleeve hole 922 and the second torsion spring hole 932 and make it the rotation axis of the torsion spring 93, the screw passes through the first sleeve hole 921 and the first torsion spring hole 931, and extends into the rotating cavity 911 to connect with the mounting hole of the pressing strip 94, so that the pressing strip 94 can rotate with the torsion spring 93, finally connect with the end cap 95 at the end, or use the screw to install the end cap 95, the sleeve 92 and the torsion spring 93 at one time by adjusting the hole position of the end cap 95.

Then, the first profile 101 and the second profile 102 are connected to form a roll bed liner assembly 10, and the front bar fixing assembly 3 and the rear bar fixing assembly 5 are respectively connected to both ends of the roll bed liner assembly 10 to form a roll bed liner body, the waterproof sheet is attached on the roll bed liner body, the binding rope 61 and the hook 62 are respectively installed on both sides of the roll bed liner body, finally, the front bar fixing assembly 3 is connected to the guide strut frame 91, the joint 103 is placed on the guide strut frame 91, and the pressing strip 94 is located on the joint 103.

When it needs to be closed in use, push the large rear bar 54, and the large rear bar 54 presses the pressing piece 96, so that the sleeve 92 will drive the pressure strip 94 to rotate, the pressure strip 94 presses the roll bed liner body 2 tightly by the supporting platform 1032 of the joint 103, finally, the locking tab 53 is clamped on the lower side of the guide strut frame 91 to lock the large rear bar 54, so as to lock the whole roll bed liner body 2.

When it needs to be opened, manually push the pull block 52 towards the fixing block 51 to make the locking tab 53 separate from the guide strut frame 91 and open the large rear bar 54, at this time, the pressing piece 96 is not forced, and the torsion spring 93 drives the pressing strip 94 to rotate by the restoring force, so that make the pressing strip 94 far away from the end cap 95, and open the roll bed liner assembly 10.

It should be noted that: the above is only the preferred embodiment of the invention, and is not used to limit the invention. Although the present invention has been described in detail with reference to the above-mentioned embodiment, for those skilled in the art, it can still modify the technical solutions recorded in the above-mentioned embodiment, or replace some of the technical features of the same. Any modification, equivalent replacement, improvement, etc. made within the spirit and principle of the invention shall be included in the scope of protection of the invention.

1. An aluminum roll bed liner for pickup truck includes a guide strut assembly (9), a roll bed liner body (2) and a fixing clamp assembly (8);
the guide strut assembly (9) is connected to the cargo hopper (1) by fixing clamp assembly (8);
the roll bed liner body (2) is connected with the guide strut assembly (9), the roll bed liner body (2) includes a front bar fixing assembly (3), a roll bed liner assembly (10) and a rear bar fixing assembly (5), the front bar fixing assembly (3) and the rear bar fixing assembly (5) are respectively connected to both ends of the roll bed liner assembly (10), waterproof sheets are attached on the bed liner cover (2).

2. An aluminum roll bed liner for pickup truck according to claim 1, wherein, the guide strut assembly (9) includes a guide strut frame (91), a front fixing assembly and a rear fixing assembly; there are the two guide strut frames, the two guide strut frames are respectively connected to both sides of the cargo hopper (1), two ends of guide strut frame (91) are respectively connected with a front fixing assembly and a rear fixing assembly.

3. An aluminum roll bed liner for pickup truck according to claim 2, wherein, the front fixing assembly includes a sleeve (92) and a torsion spring (93), the sleeve (92) is provided with a first sleeve hole (921) and a second sleeve hole (922), the torsion spring (93) is provided with a first torsion spring hole (931) and a second torsion spring hole (932), one screw passes through the second sleeve hole (922) and the second torsion spring hole (932) and connects to the guide strut frame (91), another screw passes through first sleeve hole (921) and first torsion spring hole (931) and connects to the pressing strip (94), so that the pressing strip (94) rotates after the torsion spring (93).

4. An aluminum roll bed liner for pickup truck according to claim 2, wherein, the rear fixing assembly includes a sleeve (92) and a torsion spring (93), the sleeve (92) is provided with a first sleeve hole (921) and a second sleeve hole (922), the torsion spring (93) is provided with a first torsion spring hole (931) and a second torsion spring hole (932), as the rotation axis of the torsion spring (93), one screw passes through the second sleeve hole (922) and the second torsion spring hole (932) and connects to the connecting hole (912), another screw passes through the first sleeve hole (921) and first torsion spring hole (931), extends into the rotating cavity (911) to connect with the pressing strip (94), the rear fixing assembly also provide with a pressing piece (96) which is used to connect with the sleeve (92), and which is extended in the the middle of the roll bed liner body (2).

5. An aluminum roll bed liner for pickup truck according to claim 2, wherein, the roll bed liner assembly (10) includes a waterproof rubber strip (4), a plurality of first profiles (101) and a plurality of second profiles (102), the first profile (101) and the second profile (102) are criss-crossed and hinged with each other, the end of the first profile (101) is connected with the a joint (103), the waterproof rubber strip (4) is fitted into the joint (103), and a plurality of joints (103) are connected in series.

6. An aluminum roll bed liner for pickup truck according to claim 5, wherein, one end of the roll bed liner assembly (10) is connected with the front bar fixing assembly (3), the other end of the roll bed liner assembly is connected with the rear bar fixing assembly (5).

7. An aluminum roll bed liner for pickup truck according to claim 6, wherein, the front bar fixing assembly (3) includes a T-shaped rod (31), a front bar clamp (32) and a large front bar;
the front bar clamp (32) is connected with the guide strut frame (91),
the large front bar is hinged with the roll bed liner assembly (10) through the second profile (102),
the T-shaped rod (31) is connected with the large front bar through the front bar clamp (32).

8. An aluminum roll bed liner for pickup truck according to claim 7, wherein, the rear bar fixing assembly (5) includes a lock assembly and a large rear bar (54);
the large rear bar (54) is connected to the end of the roll bed liner assembly (10) far away from the large front bar, the large rear bar (54) is provided with a sliding groove;
the lock assembly includes a fixing block (51), a pull block (52) and a locking tab (53), the fixing block (51) and pull block (52) are both placed in the sliding groove, the fixing block (51) is fixedly arranged on the large rear bar (54), the pull block (52) is arranged on the fixing block (51) close to the guide strut frame (91), an elastic part is arranged between the pull block (52) and the fixing block (51), the elastic part is in a compressed state, the pull block (52) is connected with a locking tab (53) for clamping the guide strut frame (91).

9. An aluminum roll bed liner for pickup truck according to claim 1, wherein, includes a binding assembly, which includes binding rope (61) and hook (62), the binding rope (61) and the hook (62) are respectively connected to both sides of the roll bed liner body (2).
